(19) United States
(12) Patent Application Publication
(10) Pub. No.: US 2004/0041888 A1
(43) Pub. Date: Mar. 4, 2004

(54) Ink cartridge

(75) Inventors: Seo-Hyun Cho, Suwon-City (KR); Myung-Song Jung, Gunpo-City (KR); Young-Su Lee, Suwon-City (KR); Hyung-Hyu Hwang, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/459,447

(22) Filed: Jun. 12, 2003

(30) Foreign Application Priority Data
Aug. 29, 2002 (KR) 2002-51605

(51) Int. Cl. B41J 2/175

(52) U.S. Cl. 347/86

(57) ABSTRACT

An ink cartridge is provided with a main body divided into an ink chamber filled with ink and a foam chamber receiving an ink absorbent body, an ink head chip disposed at a lower portion of the foam chamber to spray the ink onto a printing paper, a partition forming a passage with a bottom of the main body to pass ink and air therethrough, and dividing an inside of the main body into the ink chamber and foam chamber, and an ink feeding pipe disposed lower than the passage and at a lower portion of the foam chamber to feed the ink in the foam chamber to the ink head chip.

### CROSS-REFERENCE TO RELATED APPLICATIONS

This application claims the benefit of Korean Patent Application No. 2002-51605, filed Aug. 29, 2002, in the Korean Intellectual Property Office, the disclosure of which is incorporated herein by reference.

### BACKGROUND OF THE INVENTION

1. Field of the Invention

The present invention relates to an ink cartridge, and particularly, to an ink cartridge preventing air from flowing into a printing head chip during printing using ink.

2. Description of the Related Art

Generally, an ink cartridge for an inkjet printer includes a main body filled with ink, and the ink in the main body is sprayed onto a paper by a predetermined amount at a time through an ink head chip provided to the main body.

FIG. 1 is a view showing an ink cartridge 1 disclosed in U.S. Pat. No. 5,742,311. Referring to FIG. 1, the ink cartridge 1 has a two-chamber structure to maintain a negative pressure. An inside of the ink cartridge 1 is divided into a foam chamber 4 receiving a foam 3, such as a sponge, and an ink chamber 6 filled with ink 1. The ink and foam chambers 3 and 4 are divided by a partition 5 to left and right sections. Between a lower end of the partition 5 and a bottom 1 a inside the ink cartridge 1, a passage 9 is provided to pass ink and air.

At one side of the partition 5 forming a side of the foam chamber 4, a long slot 5a is formed to feed air. The foam chamber 4 is provided at an upper portion with an air vent 1b. A lower portion of the foam chamber 4 is connected with a pipe 7 used as ink passage feeding the ink L to a printing head (not shown). At an orifice of the pipe 7 coupled to another side of the ink chamber 4, a filter 8 is disposed.

According to the above construction of the ink cartridge 1, the filter 8 is disposed higher than the passage 9 with respect to the bottom 1a of the ink cartridge 1. This may cause air to flow through an air passage inside the foam 3 to the printing head upon use of the ink cartridge 1. To prevent this, the long slot 5a is formed on the partition 5. When a surface of the ink L is disposed above the long slot 5a, the air enters the ink chamber 6 through the long slot 5a and the passage 9 so that the ink I in the ink chamber 6 can be used stably.

However, with the conventional ink cartridge of the above construction, the number of operations of a metallic mold process of the ink cartridge 1 is increased, thus a mold processing cost is increased, causing troubles in a mass production. Further, in a case that the long slot 5a gets clogged, and the air moves through the pipe 7 to the head chip, so that normal printings are not possible.

### SUMMARY OF THE INVENTION

An aspect of the invention is to solve the above and/or other problems and to provide an improved ink cartridge having a simple construction capable of blocking air from flowing into a head chip.

Additional aspects and advantages of the invention will be set forth in part in the description which follows and, in part, will be obvious from the description, or may be learned by practice of the invention.

Accordingly, an aspect of the present invention is to solve the foregoing and/or other problems by providing an ink cartridge including a main body divided into an ink chamber filled with ink and a foam chamber receiving an ink absorbent body, an ink head chip disposed at a lower portion of the foam chamber to spray the ink onto a printing paper, a partition forming a passage with a bottom of the main body to pass ink and air therethrough, and dividing the ink chamber and the foam chamber, and an ink feeding pipe disposed lower than the passage and at the lower portion of the foam chamber to feed the ink in the foam chamber to the ink head chip.

Here, the ink feeding pipe is provided at a side of the foam chamber with an ink filter filtering the ink.

According to another aspect of the invention, the ink feeding pipe is disposed in a vertically upright position such that an upper end thereof is lower than the passage.

Moreover, the main body is provided with a protruding rib, at which the ink head chip is disposed outside the form chamber, protruding from a bottom of the foam chamber to a lower direction to receive the ink feeding pipe.

### BRIEF DESCRIPTION OF THE DRAWINGS

These and/or other aspects and advantages of the invention will become apparent and more readily appreciated from the following description of the preferred embodiment, taken in conjunction with the accompanying drawings of which:

FIG. 1 is a schematic cross-sectional view showing a conventional ink cartridge;

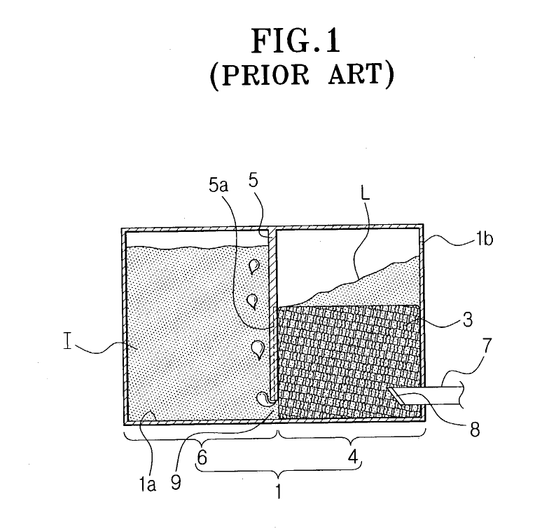

FIG. 2 is a schematic cross-sectional view showing an ink cartridge in accordance with an embodiment of the invention; and

FIG. 3 is a cross-sectional view illustrating a status of using the ink cartridge shown in FIG. 2.

### DETAILED DESCRIPTION OF THE PREFERRED EMBODIMENTS

Reference will now be made in detail to the present preferred embodiment of the present invention, examples of which are illustrated in the accompanying drawings, wherein like reference numerals refer to the like elements throughout. The embodiment is described in order to explain the present invention by referring to the figures.

An ink cartridge according to an embodiment of the invention will be hereinafter described in detail with reference to the accompanying drawings.

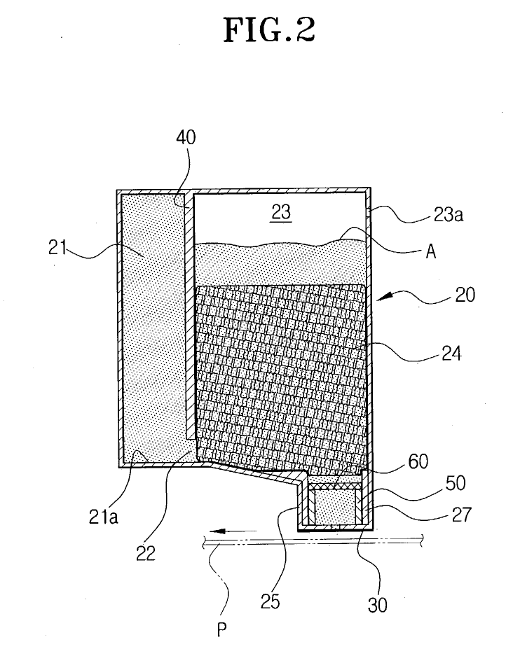

Referring to FIG. 2, the ink cartridge includes a main body 20 having an inside divided into an ink chamber 21 and a foam chamber 23, a head chip 30 disposed at a lower portion of the foam chamber 23, a partition 40 disposed inside the main body 20 to divide the ink chamber 21 and the foam chamber 23, an ink feeding pipe 50 feeding ink contained in the foam chamber 23 to the head chip 30, and a filter 60 disposed at an upper end of the ink feeding pipe 50.

Each of the ink chamber 21 and the foam chamber 23 is filled with the ink. The foam chamber 23 receives foam 40 such as a sponge. The foam chamber 23 is provided at an upper portion thereof with an air vent 23a through which air flows into the foam chamber 23.

The partition 40 is disposed inside the main body 20 of the ink cartridge in a vertically upright position. The main body 20 is provided with a passage 22 disposed between a bottom 20a thereof and the partition 40. Through the passage 22, ink and air may be fed between the ink and foam chambers 21 and 23.

The main body 20 has a protruding rib 25 protruding from a portion of the bottom 20a of the foam chamber 23 to a lower direction thereof. At an inside of the protruding rib 25, the ink feeding pipe 50 is disposed, and at an outside thereof, the head chip 30 is disposed. The protruding rib 25 may be formed as a single body with the main body 20.

The head chip 30 sprays the ink fed through the ink feeding pipe 50 onto a printing paper P based on a predetermined input data for printing. To this end, the head chip 30 includes a spray nozzle and a printing circuit controlling drive of the spray nozzle to perform printing by spraying a predetermined amount of the ink at a time according to the input data for printing.

The ink feeding pipe 50 is disposed in the protruding rib 25 communicating with an inside of the foam chamber 23 in a vertically upright position. The ink feeding pipe 50 is disposed such that an upper end thereof is lower than the passage 22. The upper end of the ink feeding pipe 50 being lower than the passage 22 enables a surface A of the ink disposed inside the foam chamber 23 to reach the passage 22 first. Thus, as the air flows through the passage 22 from the foam chamber 23 to the ink chamber 21, the ink in the ink chamber 21 may flow smoothly to the foam chamber 23. Since the ink feeding pipe 50 is lower than the passage 22, the air can be basically blocked from flowing into the ink feeding pipe 50 first.

The ink feeding pipe 50 is supported by a supporting member 27 disposed inside the protruding rib 25 to maintain the upright position. The supporting member 27 may be formed as a single body with the protruding rib 25.

The ink feeding pipe 50 is provided at the upper end thereof with the filter 60. Since the filter 60 is disposed at the upper end of the ink feeding pipe 50 and lower than the passage 22, the filter 60 filters impurities from the ink flowing from the foam chamber 23 into the ink feeding pipe 60 to prevent the spray nozzle of the head chip 30 from being clogged, or polluted ink from being sprayed through the spray nozzle of the head chip 30.

An operation of the ink cartridge according to the embodiment of the invention will be described hereinbelow.

As shown in FIG. 2, a printing operation is performed using a printer adopting the ink cartridge having the main body 20 with the ink chamber 21 and the foam chamber 23 filled with the ink. For the printing operation, the ink in the foam chamber 23 is used first. Thus, an ink level of the ink disposed only inside the foam chamber 23 is gradually lowered.

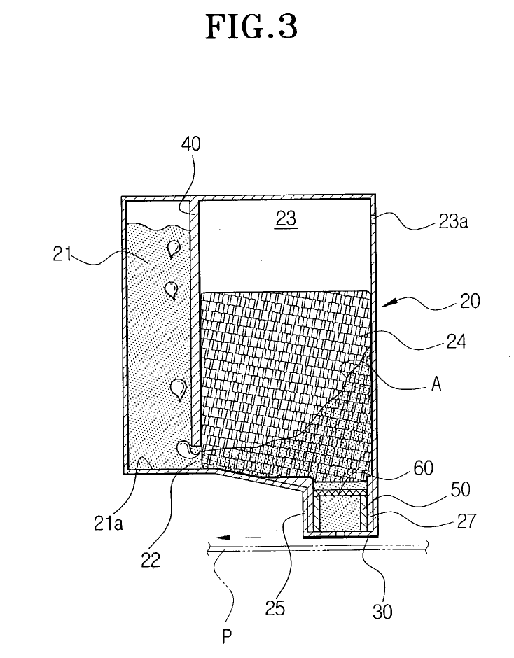

Thereafter, as shown in FIG. 3, the ink level inside the foam chamber 23 may be lowered more than the passage 22. When this happens, as the air flows through the passage 22 from the foam chamber 23 into the ink chamber 21, the ink in the ink chamber 21 flows into the foam chamber 23. Therefore, the ink flowing into the foam chamber 23 is fed to the head chip 30 through the ink filter 60 and the ink feeding pipe 50.

That is, the ink in the foam chamber 23 is used first, and then, the ink in the ink chamber 21 is used as the surface of the ink is lower than the passage 22, such as a lower side of the partition 40 forming the passage 22 with the bottom 21 a. After all of the ink in the ink chamber 21 flows into the foam chamber 23, the ink remaining in a lower portion of the foam chamber 23 is finally used.

As described above, since the filter 60 and the ink feeding pipe 50 are disposed lower than the passage 22, the air inside the foam chamber 23 may be replaced by the ink in the ink chamber 21 before the air flows into the ink feeding pipe 50 even if the ink level inside the foam chamber 23 is lowered.

Therefore, the air flowing into the ink feeding pipe 50 is basically prevented until all of the ink inside the main body 20 is used up.

With the ink cartridge according to the invention, the filter and the ink feeding pipe are disposed lower than the passage between the foam chamber and ink chamber, whereby the air does not flow into the ink feeding pipe but flows smoothly into the ink chamber as the ink level inside the foam chamber is lowered.

Therefore, an additional configuration or construction is not necessary for an air inflow to the ink chamber, thus reducing a number of operations of a manufacturing process to reduce a manufacturing cost.

While the invention has been shown and described with reference to certain preferred embodiment thereof, it will be understood by those skilled in the art that various changes in form and details may be made therein without departing from the spirit and scope of the invention as defined by the appended claims and their equivalents.

The foregoing embodiment and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. An ink cartridge comprising:
a main body divided into an ink chamber filled with ink and a foam chamber receiving an ink absorbent body;
an ink head chip disposed at a lower portion of the foam chamber to spray the ink onto a printing paper;
a partition forming a passage with a bottom of the main body to pass the ink and air therethrough, and dividing an inside of the main body into the ink chamber and the foam chamber; and
an ink feeding pipe disposed lower than the passage and at the lower portion of the foam chamber to feed the ink in the foam chamber to the ink head chip.

2. The ink cartridge according to claim 1, further comprising:
an ink filter filtering the ink, wherein the ink feeding pipe is provided at a side of the foam chamber with the ink filter.

3. The ink cartridge according to claim 1, wherein the ink feeding pipe is disposed in an upright position with respect to the bottom of the main body such that an upper end of the ink feeding pipe is lower than the passage.

4. The ink cartridge according to claim 1, wherein the main body comprises:
a protruding rib, at which the ink head chip is disposed outside the main body, protruding from the bottom of the foam chamber of the main body to a downward direction of the main body to receive the ink feeding pipe.

5. An ink cartridge comprising:
a main body having an inside defined by a first side, a second side disposed opposite to the first side, and a bottom extended from the first side toward the second side;
an ink head chip disposed at an outside of the main body to spray ink contained in the inside of the main body onto a printing paper;
a partition dividing the inside of the main body into an ink chamber filled with the ink and a foam chamber containing an ink absorbent body filled with the ink, and having a passage through which the ink chamber and the foam chamber communicate with each other; and
an ink feeding pipe disposed between the bottom and the second side of the main body and opposite to the passage with respect to the bottom of the main body to feed the ink from the foam chamber to the ink head chip.

6. The ink cartridge according to claim 5, wherein the bottom of the main body comprises:
a portion disposed in the foam chamber to slant with respect to a line perpendicular to one of first and second sides.

7. The ink cartridge according to claim 5, wherein the bottom of the main body comprises:
a portion having an angle with respect to a line perpendicular to the partition.

8. The ink cartridge according to claim 5, wherein the bottom of the main body comprises:
a first portion disposed in the ink chamber to be perpendicular to one of the first side, the second side, and the partition in the ink chamber; and
a second portion disposed in the foam chamber, extended from the first portion toward the ink feeding pipe, and disposed to slant with respect to the first portion.

9. The ink cartridge according to claim 8, wherein the ink feeding pipe is disposed between the second side and the second portion of the bottom of the main body in an outward direction of the main body.

10. The ink cartridge according to claim 5, wherein the partition forms the passage with the bottom of the main body.

11. The ink cartridge according to claim 5, wherein the main body comprises a top wall from which the partition is extended toward the bottom, and the partition has a length shorter than those of the first and second sides of the main body.

12. The ink cartridge according to claim 5, wherein the partition comprises a side facing the bottom, and the passage is formed between the side of the partition and the bottom of the main body.

13. The ink cartridge according to claim 5, wherein the main body comprises a protruding rib protruding from the bottom toward an outward direction of the main body, the protruding rib comprising an inlet disposed between the bottom and the second side of the main body to communicate with the foam chamber, and an outlet on which the ink head chip is disposed.

14. The ink cartridge according to claim 13, wherein the inlet is disposed to be opposite to the passage with respect to a plane passing through the bottom of the main body.

15. The ink cartridge according to claim 13, wherein the inlet is disposed between the passage and the outlet.

16. The ink cartridge according to claim 13, wherein the ink feeding pipe is disposed in the protruding rib.

17. The ink cartridge according to claim 16, further comprises:
a filter disposed on a portion corresponding to the inlet of the protruding rib to be coupled to the ink feeding pipe.

18. The ink cartridge according to claim 17, wherein the filter is disposed between the passage and the outlet of the protruding rib.

19. The ink cartridge according to claim 13, wherein the ink feeding pipe comprises a supporting member disposed between the protruding rib and the second side of the main body, and the ink absorbent body contained in the foam chamber contacts the second side, the partition, the bottom, and the supporting member.
